(19) United States
(12) Patent Application Publication
(10) Pub. No.: US 2023/0416053 A1
(43) Pub. Date: Dec. 28, 2023

(54) ROBOTIC INTERLOCKING ELEVATOR CONTROL SYSTEM AND METHOD

(71) Applicant: HYUNDAI ELEVATOR CO., LTD., Chungcheongbuk-do (KR)

(72) Inventors: DongHo KANG, Chungcheongbuk-do (KR); TaeRyong LEE, Chungcheongbuk-do (KR); MoonSu KIM, Chungcheongbuk-do (KR); DongHyun KWON, Chungcheongbuk-do (KR); Seok Kue LEE, Chungcheongbuk-do (KR)

(21) Appl. No.: 18/326,817

(22) Filed: May 31, 2023

(30) Foreign Application Priority Data
Jun. 23, 2022 (KR) 10-2022-0076543
Jul. 20, 2022 (KR) 10-2022-0089424

(51) Int. Cl. B66B 13/14; B66B 1/34; B66B 1/02; B66B 1/46

(52) U.S. Cl. CPC B66B 13/143; B66B 1/3461; B66B 2201/4653; B66B 1/468; B66B 1/02

(57) ABSTRACT

Disclosed is a robot interlocking elevator control system. The robot interlocking elevator control system provides countermeasures against a failure mode in a boarding/alighting procedure of a robot with respect to an elevator for movement between floors in a building, thereby achieving significant improvement in overall service quality and operation efficiency of an elevator system controlled in conjunction with the robot.

### CROSS-REFERENCE TO RELATED APPLICATION

This patent document claims priority to and the benefit of Korean Patent Application No. 10-2022-0076543, filed on Jun. 23, 2022 and Korean Patent Application No. 10-2022-0089424, filed on Jul. 20, 2022, the entire disclosure of which are incorporated by reference for all purposes as if fully set forth herein.

### BACKGROUND

### Technical Field

The present disclosure relates to an interlocking control system between an elevator system and a robot, which provides a countermeasure for a failure mode that may occur when a robot provides a floor movement service in a building by using an elevator.

### Description of the Related Art

In various buildings constructed for residential, business, and commercial purposes, elevators are installed for smooth movement of passengers between floors in the buildings.

Typically, the elevator includes an elevator car moving along a hoistway formed in a vertical direction inside a building, a mechanical part, which includes a motor for generating power for elevating the elevator car and a hoisting machine, a controller controlling operation of the elevator, and the like.

With recent activation of robot services in buildings, there is an increasing need to use elevators to move robots between floors in the building.

For example, various robots have been developed to carry out various tasks, such as transport, cleaning, and customer guidance while moving within a building. However, although commercially available robots in the art can move without difficulty in the horizontal direction in hallways or indoors with flat floors, there is a need for a means for moving the robots between floors to allow the robots to move from one floor to another floor in order to perform work on multiple floors.

Currently, the elevator is considered as the most desirable means for moving the robot between floors, and various interlocking control techniques between the robot and an elevator system are being developed in order to effectively move the robot to a destination floor.

Conventionally, the robot is controlled not to board the same elevator with humans in order to secure human safety. However, recently, as application of service robots in buildings has expanded, there have been many cases where robots and humans are required to board the same elevator.

Although there is a great need to prevent decrease in convenience or service quality for passengers due to robot services, it is not suitable to exclude the robot services, which are increasingly positively affecting real life, as optional services. Thus, there is a need for development of a harmonious interlocking control technology to improve elevator service quality for both humans and robots.

### BRIEF SUMMARY

### Technical Problem

Movement of a robot between floors in a building through an elevator is carried out as a series of processes including a process in which the robot calls an elevator car, a process in which the robot boards the elevator car that arrives at a departure floor and then moves to a destination floor, and a process in which the robot alights from the elevator car.

Here, the boarding/alighting procedure of the robot is carried out step by step while communication between the robot and the elevator controller controlling operation of the elevator is carried out, and details of the procedure are as follows.

When the robot remotely calls an elevator car, the elevator controller allocates a specific elevator car in response to the elevator call and moves the allocated elevator car to a departure floor.

When the elevator car arrives at the departure floor, the elevator controller opens the elevator door and sends a boarding permission signal to the robot to inform the robot that the robot can board the elevator car. In response to the boarding permission signal, the robot may start boarding operation with respect to the elevator car while informing the elevator controller of the robot carrying out the boarding operation by continuously sending an under-boarding signal to the elevator controller until the robot completes the boarding operation. After completion of boarding the elevator car, the robot sends a boarding completion signal to the elevator controller. Then, in response to the boarding completion signal from the robot, the elevator controller closes the elevator door to move the elevator car to the destination floor of the robot.

The alighting procedure of the robot with respect to the elevator car may be carried out in a similar way. When the elevator car receiving the robot reaches the destination floor, the elevator controller opens the elevator door and sends an alighting permission signal to the robot to inform the robot that the robot can alight from the elevator car. In response to the alighting permission signal, the robot may start alighting operation with respect to the elevator car while informing the elevator controller of the robot carrying out the alighting operation by continuously sending an under-alighting signal to the elevator controller until the robot completes the alighting operation. After completion of alighting from the elevator car, the robot sends an alighting completion signal to the elevator controller. Then, in response to the alighting completion signal from the robot, the elevator controller closes the elevator door to allow the elevator car to provide another service.

On the other hand, while the above service procedure is carried out step by step, a failure mode can occur in each step. For example, upon arrival of the elevator car at the departure floor, there can be failure, such as absence of the robot on the platform, non-reception of a boarding/alighting signal from the robot, or an unexpected situation in which the robot cannot alight from the elevator for any reason. Conventionally, there are no specific countermeasures against such a failure mode and an elevator manager is allowed to take appropriate measures corresponding to situations upon occurrence of the failure mode.

In particular, conventionally, upon reception of an under-boarding or under-alighting signal, indicating that the robot performs boarding or alighting operation with respect to the elevator, from the robot, the elevator controller disables a door close button (DCB) of the elevator to perform door opening restriction until reception of a boarding completion or alighting completion signal from the robot. Thus, despite occurrence of failure for some reason in the course of performing the boarding and alighting procedure of the robot, when closing of the elevator door is disabled (door opening restriction) and operation of the elevator car is stopped, there is a problem of delaying a service for passengers boarding together with the robot or passengers waiting on another floor, thereby causing user inconvenience.

If closing of the elevator door is invalidated (opening of the elevator door is restricted) even in the event where the robot fails to alight from the elevator car and operation of the elevator car is stopped until the robot completely alights from the elevator car, passengers riding together with the robot in the elevator will feel very uncomfortable.

Even when the elevator door is closed in a state where the robot fails to alight from the elevator car, the robot can be trapped inside the elevator car or can alight from the elevator car at a floor different from a destination floor of the robot.

If the robot stops to operate immediately inside the elevator car due to alighting failure, it is troublesome for a passenger to come to and retrieve the robot directly. When the robot alights at a floor different from the destination floor, there is a problem in that the robot can get lost due to difference in floor data and structure recognized by the robot.

Moreover, in order for the robot having alighted at the floor different from the destination floor to reach the destination floor, the robot is required to perform a series of processes for movement between floors after calling the elevator again at the floor where the robot alights, thereby causing extension of a service time by the robot.

The present disclosure has been conceived to solve such problems in the art and it is an object of the present disclosure to provide a robot interlocking elevator control system that provides a detailed countermeasure against occurrence of a failure mode in an elevator boarding/alighting procedure of the robot, particularly against a situation where a boarding completion signal or an alighting completion signal is not received after boarding or alighting operation of the robot is started, thereby achieving significant improvement in overall service quality and operation efficiency of an elevator system controlled in conjunction with the robot without long-term delay of a passenger service.

In addition, the present disclosure provides a robot interlocking elevator control system capable of preventing deterioration in service quality for a user of the elevator and in operation efficiency of the robot even in the event where the robot fails to alight from the elevator for some reason, that is, upon occurrence of alighting failure of the robot, despite arrival at a destination floor after elevator boarding of the robot is completed.

It will be understood that the present disclosure is not limited to the above object and other objects of the present disclosure will become apparent to those skilled in the art from the detailed description of embodiments.

### Technical Solution

In accordance with one aspect of the present disclosure, there is provided a robot interlocking elevator control system including: an autonomous vehicle autonomously moving in a building; and an elevator controller controlling operation of an elevator installed in the building and an elevator door upon boarding/alighting of the autonomous vehicle with respect to the elevator through communication with the autonomous vehicle, wherein, in movement of the autonomous vehicle using the elevator between floors in the building, the elevator controller releases disablement of a door close button of the elevator when a predetermined period of time has elapsed after reception of an under-boarding signal sent from the autonomous vehicle and indicating start of boarding on the elevator or an under-alighting signal sent from the autonomous vehicle and indicating start of alighting from the elevator, upon occurrence of at least one of a failure mode in which the elevator controller does not receive a boarding completion signal sent from the autonomous vehicle and indicating completion of boarding on the elevator after reception of the under-boarding signal; and a failure mode in which the elevator controller does not receive an alighting completion signal sent from the autonomous vehicle and indicating completion of alighting from the elevator after reception of the under-alighting signal.

The elevator controller may release disablement of the door close button under conditions that the autonomous vehicle is not detected within an elevator door zone.

The elevator controller may not automatically close the elevator door while releasing disablement of the door close button.

Upon occurrence of alighting failure of the autonomous vehicle despite arrival at a destination floor after boarding of the autonomous vehicle on the elevator is completed, the elevator controller may store the destination floor as an alighting failure floor in a memory, preferentially perform a passenger call service for another floor, and automatically return the allocated elevator to the alighting failure floor to perform alighting of the autonomous vehicle again.

In response to a request for a new passenger call service in the course of performing the passenger call service for the other floor, the elevator controller may automatically return the allocated elevator to the alighting failure floor after completion of the new passenger call service.

When the elevator is allowed to pass through the alighting failure floor in the course of performing the new passenger call service, the elevator controller may stop the elevator on the alighting failure floor to allow alighting of the autonomous vehicle therefrom, followed by moving the elevator to a requested floor for the new passenger call service.

In accordance with another aspect of the present disclosure, there is provided a robot interlocking elevator control method of a robot interlocking elevator control system including: an autonomous vehicle autonomously moving in a building; and an elevator controller controlling operation of an elevator installed in the building and an elevator door upon boarding/alighting of the autonomous vehicle with respect to the elevator through communication with the autonomous vehicle, the method including: starting, by the autonomous vehicle, boarding operation with respect to the elevator upon reception of a boarding permission signal from the elevator controller, followed by sending an under-boarding signal to the elevator controller during the boarding operation; sending, by the autonomous vehicle, a boarding completion signal to the elevator controller after completion of boarding on the elevator; controlling, by the elevator controller, the elevator receiving the autonomous vehicle through the boarding operation of the autonomous vehicle to move to a destination floor of the autonomous vehicle; starting, by the autonomous vehicle, alighting operation with respect to the elevator upon reception of an alighting permission signal from the elevator controller after arrival of the elevator at the destination floor, followed by sending an under-alighting signal to the elevator controller during the alighting operation; and sending, by the autonomous vehicle, an alighting completion signal to the elevator controller after completion of alighting from the elevator, wherein the elevator controller releases disablement of a door close button of the elevator when a predetermined period of time has elapsed after reception of the under-boarding signal or the under-alighting signal upon occurrence of at least one of a failure mode in which the elevator controller does not receive the boarding completion signal after reception of the under-boarding signal from the autonomous vehicle; and a failure mode in which the elevator controller does not receive the alighting completion signal after reception of the under-alighting signal from the autonomous vehicle.

The elevator controller may release disablement of the door close button under conditions that the autonomous vehicle is not detected within an elevator door zone.

The elevator controller may not automatically close the elevator door while releasing disablement of the door close button.

### Advantageous Effects

The robot interlocking elevator control system according to the present disclosure provides detailed countermeasures against occurrence of a failure mode in an elevator boarding/alighting procedure of the robot, particularly against a situation where a boarding completion signal or an alighting completion signal is not received after boarding or alighting operation of the robot is started, thereby achieving significant improvement in overall service quality and operation efficiency of an elevator system controlled in conjunction with the robot without long-term delay of a passenger service.

In a situation where a robot fails to alight from an elevator for some reason, that is, upon occurrence of alighting failure of the robot, despite arrival at a destination floor after elevator boarding of the robot is completed, the robot interlocking elevator control system according to the present disclosure also may control an elevator system in conjunction with the robot such that the elevator can return to an alighting failure floor to allow the robot to alight therefrom after finishing a passenger call service for another floor, so efficient task performance of the robot can be achieved without deterioration in service quality for an elevator user.

The present disclosure is not limited thereto and other effects of the present disclosure will become apparent from the following description.

### BRIEF DESCRIPTION OF THE SEVERAL VIEWS OF THE DRAWINGS

FIG. 1 is a schematic block diagram of a robot interlocking elevator control system according to the present disclosure.

FIG. 2 is a view illustrating a process in which an autonomous vehicle according to the present disclosure uses an elevator for movement between floors in a building.

FIG. 3 is a flowchart illustrating a robot interlocking elevator control method to the present disclosure when an alighting failure of an autonomous vehicle occurs.

### DETAILED DESCRIPTION

Hereinafter, exemplary embodiments of the present disclosure will be described in detail with reference to the accompanying drawings. It should be understood that the present disclosure is not limited to the following embodiments and may be embodied in different ways, and that the embodiments are provided for complete disclosure and thorough understanding of the present disclosure by those skilled in the art. The scope of the present disclosure is defined only by the claims. Like components will be denoted by like reference numerals throughout the specification.

The terminology used herein is for the purpose of describing particular embodiments and is not intended to be limiting. As used herein, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. Moreover, the singular forms, “a,” “an,” and “the” are intended to include the plural forms as well, unless the context clearly indicates otherwise.

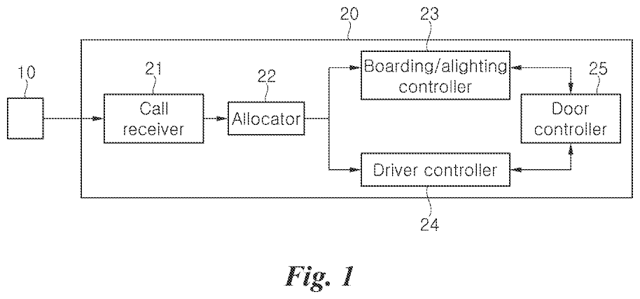

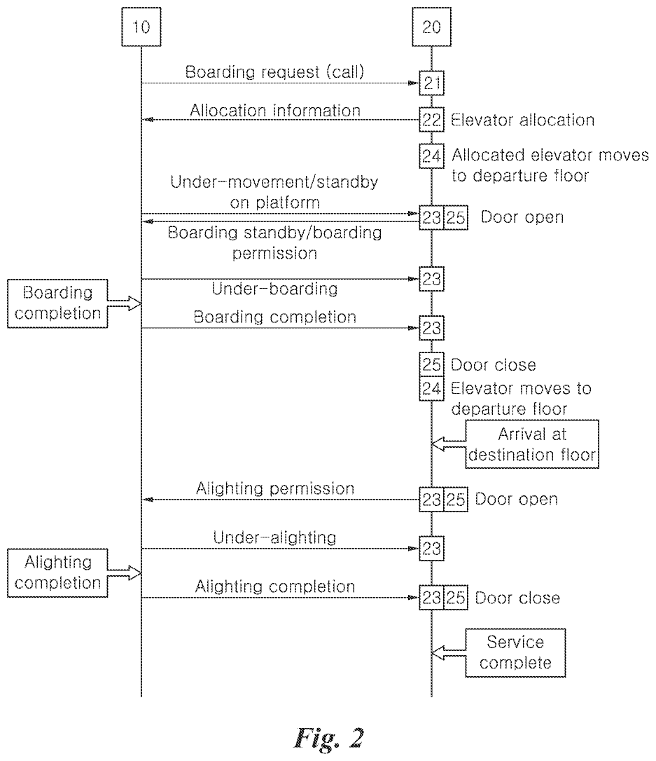

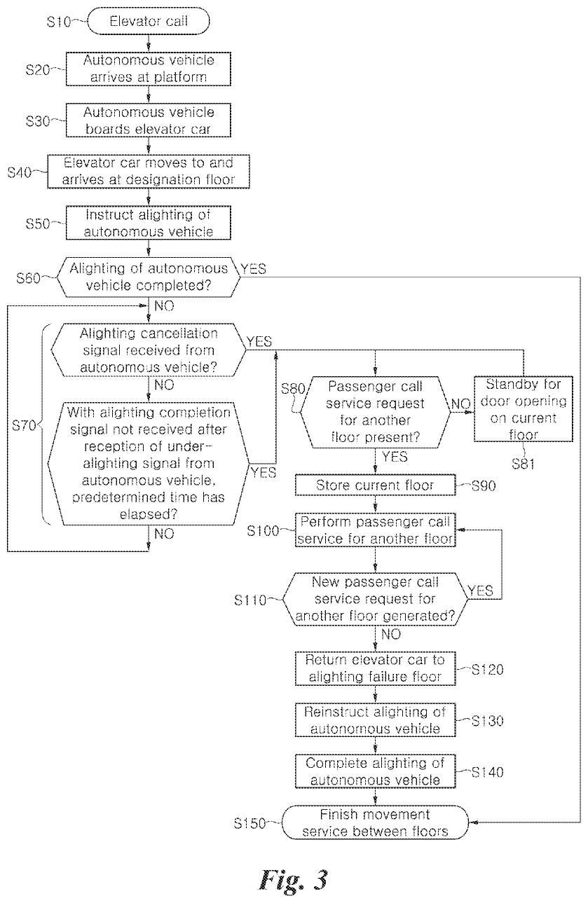

FIG. 1 is a schematic block diagram of a robot interlocking elevator control system according to the present disclosure. FIG. 2 is a view illustrating a process in which an autonomous vehicle according to the present disclosure uses an elevator for movement between floors in a building. FIG. 3 is a flowchart illustrating a robot interlocking elevator control method to the present disclosure when an alighting failure of an autonomous vehicle occurs.

Referring to FIG. 1, the robot interlocking elevator control system according to the present disclosure includes an autonomous vehicle 10 autonomously moving in a building and an elevator controller 20 controlling operation of an elevator disposed inside the building through communication with the autonomous vehicle 10 to perform interlocking control of the autonomous vehicle 10 and the elevator.

Herein, the autonomous vehicle 10 collectively refers to all kinds of mobile devices including robots and capable of autonomously moving without human manipulation in a building. By way of example, the autonomous vehicle 10 may be a service robot that carries out tasks, such as transport including parcel delivery, cleaning, and customer guidance, and the like, and may be interlinked with a robot management system (not shown) in a building to provide services for passengers in the building.

The autonomous vehicle 10 may communicate with the elevator controller 20 that controls operation of the elevator and movement of the autonomous vehicle 10 between floors in the building may be implemented through interlocking control of the elevator controller 20. The autonomous vehicle 10 may send and receive signals, which relate to elevator call, destination floor registration, and boarding/alighting operations, to and from the elevator controller 20, and details of corresponding operations will be described below.

Communication between the autonomous vehicle 10, the elevator controller 20 and the building management system may be implemented through wired or wireless communication, such as Bluetooth, Wi-Fi, CAN, WAN, and the like.

The autonomous vehicle 10 may recognize a space within a building through simultaneous localization and mapping (SLAM) based on information collected using a Lidar, a short-distance sensor, an ultrasonic sensor and a camera, and may move autonomously therein.

In addition, the autonomous vehicle 10 may store information regarding an internal/external structure of the building and a location of the elevator in the building through a database thereof, and may calculate an optimal distance and a movement route from a current location to the elevator calculated in real time using an internal algorithm based on a self-location estimation technique.

The elevator controller 20 controls overall operation and movement of the elevator. The elevator controller 20 may allocate an optimal elevator car in response to a call from each floor in the building, including button input by a passenger, a remote call, or a call received by the autonomous vehicle 10, and may control the allocated elevator car to move to the floor where the corresponding call is sent.

The elevator controller 20 may include a call receiver 21 receiving an elevator call signal generated by a passenger or the autonomous vehicle 10; an allocator 22 selecting an optimal elevator among multiple elevator cars in the building to allocate the optimal elevator in response to the elevator call signal; a boarding/alighting controller 23 controlling boarding/alighting operation of the autonomous vehicle 10 with respect to the elevator car; and a drive controller 24 controlling operation of the elevator car.

Although the elevator controller 20 may provide a service of allocating and moving an optimal elevator car in response to button input by a passenger or a remote call, this operation can be realized using a technique well-known in the art. Thus, the following description will focus on control related to the autonomous vehicle 10.

The call receiver 21 may receive an elevator boarding request from the autonomous vehicle 10. Information included in the elevator boarding request may further include departure floor information regarding a current location of the autonomous vehicle 10, destination floor information regarding a destination floor of the autonomous vehicle 10, information regarding a movement time of the autonomous vehicle 10 for arrival at an elevator platform, information regarding the weight, volume and purpose of use of the elevator, and the like.

Upon reception of an elevator boarding request from the autonomous vehicle 10, the allocator 22 may select and allocate the most efficient elevator car through correlation analysis of a traffic volume and information regarding the locations of multiple available elevator cars and the autonomous vehicle 10 within the building.

More specifically, the allocator 22 may detect status information regarding occupancy or remaining capacity of multiple elevator cars operating in the building, and may extract available elevator cars allowing the autonomous vehicle 10 to board based on the weight, volume and the like of the autonomous vehicle 10 included in the elevator boarding request information received from the autonomous vehicle 10.

In addition, the allocator 22 may allocate an optimal elevator car in consideration of the locations of the extracted available elevator cars and the autonomous vehicle 10. Here, not only information regarding a call floor on which the autonomous vehicle 10 requests elevator boarding but also information regarding a movement time of the autonomous vehicle 10 from a current location to the platform may also be considered in selection of the optimal elevator car.

In addition, the elevator controller 20 may further include an autonomous vehicle location collector (not shown) that traces the location of the autonomous vehicle 10 in the building in real time to calculate a movement time of the autonomous vehicle 10 from the current location to the platform based on a signal sent from the autonomous vehicle 10, instead of allowing the autonomous vehicle 10 to calculate location information thereof.

The boarding/alighting controller 23 may manage and control overall operation for the autonomous vehicle 10, which requests elevator boarding, to board or alight from the allocated elevator car.

For example, the autonomous vehicle 10 may send an under-movement signal to the boarding/alighting controller 23 in the course of moving towards the platform and may send an under-standby signal thereto to inform the boarding/alighting controller 23 of the autonomous vehicle 10 being in a standby state on the platform when the autonomous vehicle 10 has already reached the platform. Then, the boarding/alighting controller 23 may determine, based on information sent from the autonomous vehicle 10, whether the autonomous vehicle 10 can board the elevator, and may send a signal instructing the autonomous vehicle 10 to board the corresponding elevator car upon determining that the autonomous vehicle 10 can board the elevator.

In addition, for alighting operation of the autonomous vehicle 10, the boarding/alighting controller 23 may instruct the autonomous vehicle 10 to alight from the elevator car when the autonomous vehicle 10 arrives at the destination floor after boarding of the autonomous vehicle 10 on the elevator car is completed.

Further, in order for the autonomous vehicle 10 to implement boarding/alighting operation with respect to the elevator car, the boarding/alighting controller 23 may be interlinked with the door controller 25 that controls opening/closing of a door of the elevator car stopped on a service floor and a door of the corresponding platform.

The drive controller 24 serves to control driving of the elevator car to move upwards or downwards in a hoistway formed in the building in the vertical direction and may control a hoist motor to start driving of the elevator car or a brake to stop the elevator car.

In addition, the drive controller 24 according to this embodiment may control operation of the elevator car by generating a command signal to control the allocated elevator car to move to a floor, on which the autonomous vehicle 10 is placed, or a command signal to control the elevator car receiving the autonomous vehicle 10 through the boarding operation of the autonomous vehicle 10 to move to the destination floor of the autonomous vehicle 10, in response to the elevator boarding request from the autonomous vehicle 10.

Hereinafter, referring to FIG. 2, a process of using the elevator for movement of the autonomous vehicle 10 between floors in the building will be sequentially described according to a series of processes.

The autonomous vehicle 10 may remotely call an elevator car through wired or wireless communication with the elevator controller 20. When there is a need for movement between floors in the building, the autonomous vehicle 10 may send a boarding request signal, which requests a call of the elevator car, to the elevator controller 20.

When the call receiver 21 of the elevator controller 20 receives the boarding request signal from the autonomous vehicle 10, the allocator 22 allocates an optimal elevator car among multiple available elevator cars based on the information included in the boarding request signal and the information regarding the locations of available elevator cars in the building. The allocator 22 may provide the allocated elevator car and platform information corresponding thereto to the autonomous vehicle 10.

In response to the platform information corresponding to the allocated elevator car, the autonomous vehicle 10 may move to the corresponding platform while periodically reporting a movement situation to the elevator controller 20. In addition, the autonomous vehicle 10 may send a standby signal indicating that the autonomous vehicle 10 is in a standby state on the platform, upon arrival at the corresponding platform.

The elevator controller 20 may detect whether the autonomous vehicle 10 arrives at the platform corresponding to the allocated elevator car. Here, arrival of the autonomous vehicle 10 at the platform may be determined based on the location information obtained by the autonomous vehicle 10 through the self-location estimation technique or the location information of the autonomous vehicle 10 collected through a separate autonomous vehicle location collector (not shown), as described above.

Upon detection of the autonomous vehicle 10 on the platform, the boarding/alighting controller 23 of the elevator controller 20 may send a boarding permission signal to the autonomous vehicle 10 after opening the door of the elevator car.

When the autonomous vehicle 10 arrives at the platform later than the elevator car, the elevator controller 20 may control the doors of the elevator car and the platform to stand by in an open state until the autonomous vehicle 10 arrives at the platform, in the case where an arrival prediction time of the autonomous vehicle 10 is less than or equal to a preset value, and the elevator controller 20 may send a cancellation signal to the autonomous vehicle 10 for cancellation of a current call of the autonomous vehicle 10 in the case where the arrival prediction time of the autonomous vehicle 10 exceeds the preset value. In response to the cancellation signal, the autonomous vehicle 10 may recall the elevator and the elevator controller 20 may allocate an optimal elevator car in response to a recall signal from the autonomous vehicle 10 and may control the optimal elevator car to move to a service floor.

In response to the boarding permission signal from the boarding/alighting controller 23, the autonomous vehicle 10 performs boarding operation with respect to the allocated elevator car. The autonomous vehicle 10 may inform the boarding/alighting controller 23 of the autonomous vehicle 10 being under boarding operation by continuously sending the under-boarding signal to the boarding/alighting controller 23 from a start time of the boarding operation to a completion time thereof. The boarding/alighting controller 23 may control the elevator door not to be closed in cooperation with the door controller 25 while the autonomous vehicle 10 passes through the elevator door.

When the boarding operation of the autonomous vehicle 10 with respect to the elevator car is completed, the autonomous vehicle 10 may send a boarding completion signal to the boarding/alighting controller 23.

In response to the boarding completion signal from the autonomous vehicle 10, the elevator controller 20 may close the elevator door and may automatically register the destination floor of the autonomous vehicle 10 to control the elevator car to move to destination floor of the autonomous vehicle 10.

When the elevator car arrives at the destination floor of the autonomous vehicle 10, the elevator controller 20 may open the doors of the elevator car and the platform of the destination floor and may send an alighting permission signal to the autonomous vehicle 10 through the boarding/alighting controller 23 to instruct the autonomous vehicle 10 to alight from the elevator car.

In response to the alighting permission signal, the autonomous vehicle 10 performs alighting operation with respect to the elevator car. Here, the autonomous vehicle 10 may inform the boarding/alighting controller 23 of the autonomous vehicle 10 being under alighting operation by continuously sending the under-alighting signal to the boarding/alighting controller 23 from a start time of the alighting operation to a completion time thereof, and the boarding/alighting controller 23 may control the elevator door so as not to be closed in cooperation with the door controller 25 while the autonomous vehicle 10 passes through the elevator door.

When the alighting operation of the autonomous vehicle 10 with respect to the elevator car is completed, the autonomous vehicle 10 may send an alighting completion signal to the boarding/alighting controller 23.

In response to the alighting completion signal from the autonomous vehicle 10, the elevator controller 20 may close the elevator door and may complete an inter-floor movement service for the autonomous vehicle 10.

On the other hand, in the course of performing the series of operations, various failure modes relating to boarding and alighting of the autonomous vehicle 10 can occur as follows, for example:
1) a case where a platform standby state of the autonomous vehicle 10 is not recognized when the elevator car arrives at a call floor in response to an elevator call from the autonomous vehicle 10, that is, a case where the elevator controller 20 does not receive a platform standby signal from the autonomous vehicle 10, despite generation of a boarding request (call) by the autonomous vehicle 10 and arrival of the elevator at a departure floor in response to the boarding call;
2) a case where boarding operation of the autonomous vehicle 10 is not started for a predetermined period of time or more after arrival of the elevator car at a call floor in response to an elevator call from the autonomous vehicle 10, that is, a case where the elevator controller 20 does not receive an under-boarding signal from the autonomous vehicle 10, despite reception of the platform standby signal from the autonomous vehicle 10 and transmission of a boarding permission signal to the autonomous vehicle 10;
3) a case where boarding completion of the autonomous vehicle 10 is not recognized as the next step despite recognition of an under-boarding state of the autonomous vehicle with respect to the elevator car, that is, a case where the elevator controller 20 does not receive a boarding completion signal from the autonomous vehicle 10 despite reception of the under-boarding signal therefrom;
4) a case where alighting operation of the autonomous vehicle 10 is not started for a predetermined period of time or more despite arrival of the elevator car receiving the autonomous vehicle 10 at a destination floor, that is, a case where the elevator controller 20 does not receive an under-alighting signal from the autonomous vehicle 10, despite transmission of an alighting permission signal to the autonomous vehicle 10 after reception of a boarding completion signal from the autonomous vehicle 10 and arrival of the elevator car receiving the autonomous vehicle 10 at the destination floor; and
5) a case where alighting completion of the autonomous vehicle 10 is not recognized despite recognition of an under-alighting state of the autonomous vehicle 10 with respect to the elevator car, that is, a case where the elevator controller 20 does not receive an alighting completion signal from the autonomous vehicle 10 despite reception of the under-alighting signal therefrom.

Among the above failure modes occurring in each step, since cases 3) and 5) are failure modes that occur after the autonomous vehicle 10 sends a signal indicating boarding or alighting with respect to the elevator car, the failure modes may include a case where the autonomous vehicle 10 cannot perform boarding/alighting operation any more due to occurrence of breakdown or overturning during boarding/alighting with respect to the elevator car. Accordingly, since the autonomous vehicle 10 can be placed in an elevator door zone (door zone), there is a need for consideration of more active countermeasures.

Here, it should be noted that, even in the case where the boarding completion signal or the alighting completion signal of the autonomous vehicle 10 is not received, it does not directly mean breakdown or overturning of the autonomous vehicle 10 and there can be a situation where the elevator controller does not recognize boarding/alighting completion of the autonomous vehicle 10 due to a communication problem between the autonomous vehicle 10 and the elevator controller 20 during boarding/alighting of the autonomous vehicle 10.

Thus, the present disclosure provides detailed countermeasures against failure modes relating to a simple communication problem and reception of the boarding completion or alighting completion signal from the autonomous vehicle 10.

On the other hand, the following countermeasures may be changed depending upon whether an elevator to be used by the autonomous vehicle 10 is set to a shared mode allowing shared use of the elevator by both robots and humans or a robot exclusive mode allowing use of the elevator only by robots.

In addition, the robot interlocking elevator control system according to the present disclosure may set a predetermined time as an opening standby time of the elevator door. Here, the opening standby time of the elevator door means a period of time for which the door stands by in an open state. That is, the opening standby time may mean a period of time from a time at which the elevator door is completely open to a time immediately before the elevator door starts to be closed excluding a time for operation of opening or closing the elevator door.

In particular, the robot interlocking elevator control system according to the present disclosure may set the opening standby time of the elevator door selected from among two values, that is, a general opening standby time for boarding/alighting of general passengers (human passengers) and a robot opening standby time for boarding/alighting of the autonomous vehicle (robot), according to a setting mode of the elevator.

The general opening standby time is a typical setting value applied to opening/closing of the elevator door in the case where use of the elevator by the autonomous vehicle 10 is not scheduled. In application of the general opening standby time, the elevator door may be maintained in a completely open state for a short period of time (for example, for about 2 to 4 seconds) and may be converted to a closed state.

The robot opening standby time is a setting value applied to opening/closing of the elevator door upon boarding/alighting of the autonomous vehicle 10 through the elevator door and may be set to a longer time (for example, 40 seconds) than the general opening standby time. The general opening standby time and the opening standby time are arbitrary set values that can be changed depending upon entrance conditions of the elevator door and the like.

In addition, the elevator door to which the general opening standby time and the robot opening standby time are applied may be understood as a concept including both an elevator car door and a platform door, and setting of the door opening time and the door closing time and opening/closing of the elevator door may be controlled by the door controller 25, as described above.

Hereinafter, control logics corresponding to countermeasures upon occurrence of a failure mode, in which the boarding completion signal or the alighting completion signal of the autonomous vehicle is not received, will be described according to the setting mode of the elevator.

### I. When Boarding Completion Signal is not Received

A. Operation in Normal State

First, operation in a normal state will be briefly described for comparison with operation in a failure mode. Since reception of the boarding completion signal after reception of the under-boarding signal from the autonomous vehicle 10 means that boarding of the autonomous vehicle 10 on the elevator car has been successfully carried out, the elevator controller 20 may close the elevator door and may control the elevator car to start to move to a destination floor of the autonomous vehicle 10.

B. Countermeasure in Shared Mode

Upon reception of the under-boarding signal from the autonomous vehicle 10, the elevator controller 20 disables the door close button (DCB) and maintains the elevator door in an open state. However, despite occurrence of a problem in boarding of the autonomous vehicle 10, when the elevator car is stood by in this state until the boarding completion signal of the autonomous vehicle 10 is received, another passenger can be significantly inconvenienced.

Thus, when the elevator controller does not receive the boarding completion signal from the autonomous vehicle 10 for a predetermined period of time (preferably for the robot opening standby time) after reception of the under-boarding signal from the autonomous vehicle 10, the elevator controller may release disablement of the door close button to allow the elevator door to be closed when the door close button is pressed by a general passenger.

However, in this case, since the under-boarding signal of the autonomous vehicle 10 is received, there is a high probability that the autonomous vehicle 10 is present in the elevator door zone. Thus, the elevator controller prevents the elevator door from being automatically closed for a predetermined period of time or even when the robot opening standby time has elapsed. That is, the elevator controller releases disablement of the door close button while preventing the elevator door from being automatically closed. This operation prevents damage to the autonomous vehicle 10 due to door closing when the autonomous vehicle 10 is present in the elevator door zone.

Although the elevator door cannot be automatically closed, disablement of the door close button is released. Thus, the elevator controller may check whether another passenger using the corresponding elevator can close the elevator door, and may control the elevator car to start to move to another floor by closing the elevator door through manipulation of the door close button upon determining that the other passenger can close the elevator door.

Here, disablement of the door close button may be released only under conditions that it is determined through a detection unit (for example, a camera or an object detection sensor) in the elevator door zone that the autonomous vehicle 10 is not present in the elevator door zone. If the autonomous vehicle 10 is detected in the elevator door zone, disablement of the door close button is not released.

Further, after a predetermined period of time has elapsed, the elevator controller 20 may directly close the elevator door while releasing disablement of the door close button of the elevator, when the autonomous vehicle 10 or other objects are not detected in the elevator door zone by the detection unit. Here, in this case, it is necessary to secure a clean state in which not only the autonomous vehicle 10 but also other objects are not detected in the elevator door zone.

C. Countermeasure in Robot Exclusive Mode

In the robot exclusive mode, the elevator controller 20 disables the door close button (DCB) and maintains the elevator door in an open state in response to the under-boarding signal from the autonomous vehicle 10.

However, since the robot exclusive mode is a mode in which use of the elevator is allowed only for the autonomous vehicle 10, the elevator controller may maintain the elevator door in an open state while maintaining disablement of the door close button, even without reception of the boarding completion signal from the autonomous vehicle 10 until a predetermined period of time elapses.

In this case, breakdown handling of the autonomous vehicle 10 may be performed, as needed, and, after completion of breakdown handling of the autonomous vehicle 10, the elevator controller 20 may release disablement of the door close button and may close the elevator door to move the elevator car to another floor in response to a specific command from the robot management system that manages the autonomous vehicle 10.

### II. When Alighting Completion Signal is not Received

A. Operation in Normal State

Since reception of the alighting completion signal after reception of the under-alighting signal from the autonomous vehicle 10 means that alighting of the autonomous vehicle 10 from the elevator car has been successfully carried out, the elevator controller 20 may close the elevator door and may complete movement service of the autonomous vehicle 10 between floors.

B. Countermeasure in Shared Mode

The countermeasure in this mode may be carried out in a similar way to the countermeasure when the boarding completion signal is not received. Upon reception of the under-alighting signal from the autonomous vehicle 10, the elevator controller 20 disables the door close button (DCB) and maintains the elevator door in an open state. In this case, however, when the elevator car is stood by until the alighting completion signal of the autonomous vehicle 10 is received, another passenger can be significantly inconvenienced. Accordingly, when the alighting completion signal of the autonomous vehicle 10 is not received for a predetermined period of time (preferably for the robot opening standby time) after reception of the under-alighting signal from the autonomous vehicle 10, the elevator controller 20 releases disablement of the door close button to allow the elevator door to be closed when the door close button is pressed by a passenger.

However, in this case, since the elevator controller receives the under-alighting signal from the autonomous vehicle 10, there is a high probability that the autonomous vehicle 10 is present in the elevator door zone. Thus, the elevator controller prevents the elevator door from being automatically closed for a predetermined period of time or even when the robot opening standby time has elapsed.

Although the elevator door cannot be automatically closed, disablement of the door close button is released. Thus, the elevator controller may check whether another passenger using the corresponding elevator can close the elevator door, and may control the elevator car to start to move to another floor by closing the elevator door through manipulation of the door close button upon determining that the other passenger can close the elevator door.

Here, disablement of the door close button may be released only under conditions that it is determined through the detection unit (for example, a camera or an object detection sensor) in the elevator door zone that the autonomous vehicle 10 is not present in the elevator door zone. If the autonomous vehicle 10 is detected in the elevator door zone, disablement of the door close button is not released.

Further, after a predetermined period of time, the elevator controller 20 may directly close the elevator door while releasing disablement of the door close button of the elevator, when the autonomous vehicle 10 or other objects are not detected in the elevator door zone by the detection unit. Here, in this case, it is necessary to secure a clean state in which not only the autonomous vehicle 10 but also other objects are not detected in the elevator door zone.

C. Countermeasure in Robot Exclusive Mode

The countermeasure in this mode may be carried out in a similar way to the countermeasure when the boarding completion signal is not received. In the robot exclusive mode, upon reception of the under-alighting signal from the autonomous vehicle 10, the elevator controller 20 disables the door close button and maintains the elevator door in an open state.

However, since the robot exclusive mode is a mode in which use of the elevator is allowed only for the autonomous vehicle 10, the elevator controller 20 may maintain the elevator door in an open state while maintaining disablement of the door close button, even without reception of the alighting completion signal from the autonomous vehicle 10 until a predetermined period of time elapses.

In this case, breakdown handling of the autonomous vehicle 10 may be performed, as needed, and, after completion of breakdown handling of the autonomous vehicle 10, the elevator controller 20 may release disablement of the door close button and may close the elevator door to move the elevator car to another floor in response to a specific command from the robot management system that manages the autonomous vehicle 10.

The countermeasures according to the setting mode of the elevator when the boarding completion or alighting completion signal of the autonomous vehicle 10 is not received may be summarized as in the following Table 1.

TABLE 1

| Setting mode | Door control | DCB control |
|---|---|---|
| Shared mode | Standby and open state | Disablement of DCB for |
| | maintained for robot | opening standby time |
| | opening standby time | After robot opening standby |
| | | time, disablement of DCB is |
| | | released under conditions that |
| | | autonomous vehicle is not |
| | | detected in elevator door zone |
| Robot | Standby and open state | Disablement of DCB is |
| exclusive mode | maintained for robot | maintained |
| | opening standby time | disablement of DCB is |
| | | released by specific command |
| | | from robot management |
| | | system |

As described above, the robot interlocking elevator control system according to the present disclosure provides countermeasures of controlling the elevator door while releasing door opening restriction (disablement of the door close button) under a predetermined condition, upon failure occurrence in a boarding/alighting procedure of a robot with respect to the elevator for movement between floors in a building, particularly in the situation where the boarding completion signal or the alighting completion signal is not received after boarding or alighting operation of the robot is started, thereby effectively preventing delay of a passenger service while enabling efficient operation efficiency of the elevator.

Meanwhile, since the elevator set in the shared mode performs the call services by both the robot and the passenger, it is necessary to control the operation of the elevator in consideration of service efficiency for both of them.

According to the present disclosure, a control logic for an elevator is configured as follows, so as to prevent deterioration in service quality for a user boarding in the elevator car and in operation efficiency of the autonomous vehicle 10 upon occurrence of an “alighting failure” in which the autonomous vehicle 10 does not properly alight at the destination floor even though the autonomous vehicle 10 arrives at the destination floor after completing the boarding of the elevator car.

Examples of alighting failure of the autonomous vehicle 10 are as follows:

In the case where the autonomous vehicle 10 fails to receive data corresponding to the alighting permission signal and passes an alighting opportunity, despite arrival at a destination floor.

In the case where the autonomous vehicle 10 cannot alight from the elevator car due to congestion in the elevator car, mischief by some passengers, or items belonging to a certain passenger, despite recognition of arrival at the destination floor.

In the case where the door of the elevator car is closed by a certain passenger who presses a door close button in the elevator car in the course where the autonomous vehicle 10 tries to alight therefrom, before the autonomous vehicle 10 alights from the elevator car.

In the case where the elevator car does not stop on the corresponding destination floor due to cancellation of designation to the destination floor registered by the autonomous vehicle 10 for some reason.

When the elevator car is requested to provide a passenger call service for another floor in the event where the autonomous vehicle 10 fails to alight from the elevator car on the destination floor after boarding the elevator car, the robot interlocking elevator control system according to the present disclosure stores the current floor (alighting failure floor) in a memory, converts the elevator door into a closed state to preferentially perform the passenger call service for the other floor, and automatically returns the elevator car to the alighting destination floor of the autonomous vehicle 10 to allow the autonomous vehicle 10 to alight from the elevator car.

In addition, when the elevator car is further requested to provide a new passenger call service in the course of preferentially performing the passenger call service for the other floor after alighting failure of the autonomous vehicle 10, the robot interlocking elevator control system according to the present disclosure may control the elevator car to move to the alighting destination floor of the autonomous vehicle 10 after service for the newly registered call is completed and there is no additional call for another floor.

That is, the robot interlocking elevator control system according to the present disclosure may control the elevator car to return to the alighting destination floor of the autonomous vehicle 10 under conditions that an additional passenger call service request is not generated, after completion of not only a previously registered passenger call service request upon occurrence of alighting failure of the autonomous vehicle 10 but also a new passenger call service request generated in the course of performing the previously registered passenger call service after alighting failure of the autonomous vehicle 10.

However, when the elevator car is controlled to pass through the alighting destination floor of the autonomous vehicle 10 in the course of moving to a new call floor to provide a service, the elevator car may be controlled to move to the new call floor after stopping on the alighting destination floor of the autonomous vehicle 10 to allow the autonomous vehicle 10 to alight from the elevator car.

If the new call floor is the same as the alighting destination floor of the autonomous vehicle 10, alighting of the autonomous vehicle 10 from the elevator car is performed when the elevator car stops on the corresponding floor.

According to the present disclosure, upon occurrence of alighting failure of the autonomous vehicle 10, a preferential service may be limited to a call service request from human passengers. That is, it should be noted that the present disclosure is not applied to the case where there is a call service request from other autonomous vehicles upon occurrence of alighting failure of the autonomous vehicle 10.

Herein, the expression “passenger call service request” may include a service request for calling the elevator car to a corresponding floor through a button of the platform on another floor or through a remote call, and a service request from a passenger who is already in the elevator car and designates another floor as a destination floor by pressing a button in the elevator car.

Typically, in an elevator boarding/alighting mode of a robot, the elevator controller temporarily disables control of the elevator door. Specifically, when the elevator controller sends a boarding permission command or an alighting permission command to the robot, the elevator controller nullifies closing of the elevator door to set the elevator door in an opening restriction state until the elevator controller receives a boarding completion signal or an alighting completion signal from the robot.

However, when the opening restriction state of the elevator door is maintained until the elevator controller receives the alighting completion signal from the autonomous vehicle 10 despite alighting failure of the autonomous vehicle 10 from the destination floor, general users in the same elevator car can suffer from a very significant inconvenience.

The elevator control system according to the present disclosure may be configured to release door opening restriction of the elevator car to allow the passenger call service for the other floor to be preferentially carried out under a predetermined condition upon occurrence of alighting failure of the autonomous vehicle 10.

First, upon determining that the autonomous vehicle 10 cannot alight from the destination floor based on a detection result of an alighting path by a camera or a space detection sensor provided to the autonomous vehicle 10, the autonomous vehicle 10 may generate and send an alighting cancellation signal to the boarding/alighting controller 23.

In addition, when a detector, such as a space recognition camera and the like, disposed in the elevator car, detects the situation that the autonomous vehicle 10 cannot alight from the elevator car, the detector may send the alighting cancellation signal to the boarding/alighting controller 23 through the autonomous vehicle 10.

Further, when the door of the elevator car is closed for some reason without the alighting completion signal despite reception of the under-alighting signal from the autonomous vehicle 10 or when the alighting completion signal is not received until an alighting restriction time of the autonomous vehicle 10 is exceeded despite reception of the under-alighting signal from the autonomous vehicle 10, the boarding/alighting controller 23 may generate the alighting cancellation signal. Here, the alighting restriction time of the autonomous vehicle 10 is a preset arbitrary value and may be changed depending on the size of the elevator, specifications of the autonomous vehicle 10, and the like.

When the alighting cancellation signal is sent from the autonomous vehicle 10 to the boarding/alighting controller 23 or generated by the boarding/alighting controller 23, the elevator controller 20 may store information regarding a current floor, that is, information regarding the alighting failure floor of the autonomous vehicle 10, in the memory, and may release door opening restriction of the elevator car to convert the door into a closed state and to allow departure of the elevator car for a passenger for another floor.

In addition, the elevator controller 20 may control the elevator car to return to the alighting destination floor of the autonomous vehicle 10 after completion of all services with respect to a previously registered passenger call for another floor and a newly registered passenger call.

When the elevator car returns to the alighting destination floor of the autonomous vehicle 10 after completion of services for other floors, the elevator controller 20 may send the alighting permission signal to the autonomous vehicle 10 to guide the autonomous vehicle 10 to alight from the elevator car while maintaining the elevator door in an open state for a predetermined period of time as in an existing alighting procedure.

When a passenger call service request for another floor is not generated despite alighting failure of the autonomous vehicle 10, the elevator controller 20 may stand by until reception of the alighting completion of the autonomous vehicle 10 while maintaining the door of the elevator car in the open state.

That is, when there is no passenger call service request for another floor even in the case where a predetermined alighting restriction time is exceeded without recognition of alighting completion while the autonomous vehicle 10 alights from the elevator car, the elevator controller 20 may continue to provide an opportunity for the autonomous vehicle 10 to alight from the elevator car by maintaining the elevator door in an open state on a current alighting floor.

Next, a robot interlocking elevator control method according to the present disclosure will be described with reference to FIG. 3.

Referring to FIG. 3, the robot interlocking elevator control method according to the present disclosure may include: calling an elevator car in response to a boarding request from an autonomous vehicle 10 (S10); arriving, by the autonomous vehicle 10, at a platform of a departure floor (call floor) (S20); boarding, by the autonomous vehicle 10, an allocated elevator car on the departure floor platform (S30); controlling an elevator car receiving the autonomous vehicle 10 therein to move from the departure floor and to arrive at a destination floor (S40); instructing the autonomous vehicle 10 to alight from the elevator car (S50); detecting whether alighting of the autonomous vehicle 10 is completed (S60); confirming whether an alighting cancellation signal requesting cancellation of alighting of the autonomous vehicle 10 is received, when an alighting completion signal of the autonomous vehicle 10 is not received (S70); confirming the presence of a passenger call service request for another floor in response to the alighting cancellation signal with respect to the autonomous vehicle 10 (S80); storing information regarding a current floor, on which alighting failure of the autonomous vehicle 10 occurs, in a memory upon determining that the passenger call service request for the other floor is present (S90); preferentially performing the passenger call service for the other floor (S100); checking generation of a new passenger call service request in the course of performing the passenger call service for the other floor, followed by performing the new passenger call service for a corresponding floor upon determining that the new passenger call service request is generated (S110); returning the elevator car receiving the autonomous vehicle 10 therein to the alighting failure floor stored in the memory under conditions that a new passenger call service request is not further generated (S120); opening an elevator door, followed by instructing the autonomous vehicle 10 to alight from the elevator car, upon arrival of the elevator car at the alighting failure floor (S130); completing alighting of the autonomous vehicle 10 (S140); and finishing a movement service of the autonomous vehicle 10 between floors (S150).

Since features of each of the steps can be easily understood with reference to interlocking control between the autonomous vehicle 10 and the elevator system and the control logics upon alighting failure of the autonomous vehicle 10 described above, detailed description thereof will be omitted.

Upon normal reception of the alighting completion signal from the autonomous vehicle 10 in S60, the movement service of the autonomous vehicle 10 between floors may be finished by recognizing that movement of the autonomous vehicle 10 using the elevator car between floors is successfully performed (S150).

When the passenger call service request for the other floor is not confirmed in S80, the method may further include guiding alighting of the autonomous vehicle 10 from the elevator car while maintaining the elevator door in an open state on a current floor (S81), and proceeding to the next step (S90) upon occurrence of a passenger call service request for another floor.

The robot interlocking elevator control system according to the present disclosure may be implemented by a server corresponding to a computer or a program that processes signals received from the autonomous vehicle 10 and the elevator controller 20 and generate and output commands corresponding to the signals. In addition, the robot interlocking elevator control system may include a recording medium in which data is stored and recorded during the process, and examples of the recording medium include ROM, RAM, CD-ROM, a magnetic tape, a floppy disk, an optical data storage device, and the like.

Although some embodiments have been described herein, it should be understood that these embodiments are given by way of illustration only, and that various modifications, variations, and alterations can be made by those skilled in the art without departing from the spirit and scope of the present disclosure. Therefore, the scope of the disclosure should be limited only by the appended claims and equivalents thereto.

### LIST OF REFERENCE NUMERALS

10: Autonomous vehicle
20: Elevator controller
21: Call receiver
22: Allocator
23: Boarding/alighting controller
24: Drive controller
25: Door controller

1. A robot interlocking elevator control system, comprising:
an autonomous vehicle autonomously moving in a building; and
an elevator controller controlling operation of an elevator installed in the building and an elevator door upon boarding/alighting of the autonomous vehicle with respect to the elevator through communication with the autonomous vehicle,
wherein, in movement of the autonomous vehicle using the elevator between floors in the building, the elevator controller releases disablement of a door close button of the elevator when a predetermined period of time has elapsed after reception of an under-boarding signal sent from the autonomous vehicle and indicating start of boarding the elevator or an under-alighting signal sent from the autonomous vehicle and indicating start of alighting from the elevator, upon occurrence of at least one of a failure mode in which the elevator controller does not receive a boarding completion signal sent from the autonomous vehicle and indicating completion of boarding the elevator after reception of the under-boarding signal; and a failure mode in which the elevator controller does not receive an alighting completion signal sent from the autonomous vehicle and indicating completion of alighting from the elevator after reception of the under-alighting signal.

2. The robot interlocking elevator control system according to claim 1, wherein the elevator controller releases disablement of the door close button under conditions that the autonomous vehicle is not detected within an elevator door zone.

3. The robot interlocking elevator control system according to claim 2, wherein the elevator controller does not automatically close the elevator door while releasing disablement of the door close button.

4. The robot interlocking elevator control system according to claim 1, wherein upon occurrence of alighting failure of the autonomous vehicle despite arrival at a destination floor after boarding of the autonomous vehicle on the elevator is completed, the elevator controller stores the destination floor as an alighting failure floor in a memory, preferentially performs a passenger call service for another floor, and automatically returns the allocated elevator to the alighting failure floor to perform alighting of the autonomous vehicle again.

5. The robot interlocking elevator control system according to claim 4, wherein in response to a request for a new passenger call service in the course of performing the passenger call service for the other floor, the elevator controller automatically returns the allocated elevator to the alighting failure floor after completion of the new passenger call service.

6. The robot interlocking elevator control system according to claim 5, wherein, when the elevator is allowed to pass through the alighting failure floor in the course of performing the new passenger call service, the elevator controller stops the elevator on the alighting failure floor to allow alighting of the autonomous vehicle therefrom, followed by moving the elevator to a requested floor for the new passenger call service.

7. A robot interlocking elevator control method of a robot interlocking elevator control system including: an autonomous vehicle autonomously moving in a building; and an elevator controller controlling operation of an elevator installed in the building and an elevator door upon boarding/alighting of the autonomous vehicle with respect to the elevator through communication with the autonomous vehicle, the robot interlocking elevator control method comprising:
starting, by the autonomous vehicle, boarding operation with respect to the elevator upon reception of a boarding permission signal from the elevator controller, followed by sending an under-boarding signal to the elevator controller during the boarding operation;
sending, by the autonomous vehicle, a boarding completion signal to the elevator controller after completion of boarding the elevator;
controlling, by the elevator controller, the elevator receiving the autonomous vehicle through the boarding operation of the autonomous vehicle to move to a destination floor of the autonomous vehicle;
starting, by the autonomous vehicle, alighting operation with respect to the elevator upon reception of an alighting permission signal from the elevator controller after arrival of the elevator at the destination floor, followed by sending an under-alighting signal to the elevator controller during the alighting operation; and
sending, by the autonomous vehicle, an alighting completion signal to the elevator controller after completion of alighting from the elevator,
wherein the elevator controller releases disablement of a door close button of the elevator when a predetermined period of time has elapsed after reception of the under-boarding signal or the under-alighting signal upon occurrence of at least one of a failure mode in which the elevator controller does not receive the boarding completion signal after reception of the under-boarding signal from the autonomous vehicle; and a failure mode in which the elevator controller does not receive the alighting completion signal after reception of the under-alighting signal from the autonomous vehicle.

8. The robot interlocking elevator control method according to claim 7, wherein the elevator controller releases disablement of the door close button under conditions that the autonomous vehicle is not detected within an elevator door zone.

9. The robot interlocking elevator control method according to claim 8, wherein the elevator controller does not automatically close the elevator door while releasing disablement of the door close button.
